(19) United States
(12) Patent Application Publication
(10) Pub. No.: US 2006/0227375 A1
(43) Pub. Date: Oct. 12, 2006

(54) Apparatus and method for generating additional copy without rescanning

(75) Inventor: Akira Kamimura, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/091,597

(22) Filed: Mar. 29, 2005

(51) Int. Cl. G06K 15/00

(52) U.S. Cl. 358/1.16; 358/468; 358/448

(57) ABSTRACT

An apparatus and method for copying a document in an image forming apparatus includes receiving a request to copy a document, scanning the document to form image data corresponding to the document, printing the document using the image data of the document, and storing the image data of the document in a storage area of the image forming apparatus. The document is reprinted using the image data stored in the storage area of the image forming apparatus if a request is received for at least one additional copy of the document. In addition, the image data of the document is deleted from the storage area if a predetermined event is detected after printing the document.

### FIELD OF THE INVENTION

The present invention relates generally to image forming apparatuses and, more particularly, to a system and method for generating an additional copy of an original document without rescanning.

### BACKGROUND OF THE INVENTION

To make a copy of a document, a user can use a copying machine, a multi-function peripheral (MFP) having a copying capability, or other type of image forming apparatus. When inputting the settings and parameters for the copy job, the user sets the number of copies to be made of the document being copied. After initiating the copy job, the set number of copies are generated. However, in the event that the user wishes to make one or more additional copies after initiating the copy job, the user must rescan the document. If the document has a significant number of pages, the rescanning of the document results in a considerable waste of time as well as additional wear and tear on the image forming apparatus.

It would be desirable to avoid the rescanning of the document if the user desires to make an additional copy or copies after initiating a copy job.

### SUMMARY OF THE INVENTION

According to an aspect of the invention, an image forming apparatus and method for copying a document in an image forming apparatus, includes receiving a request to copy a document, scanning the document to form image data corresponding to the document, printing the document using the image data of the document, storing the image data of the document in a storage area of the image forming apparatus, reprinting the document using the image data stored in the storage area of the image forming apparatus if a request is received for at least one additional copy of the document, and deleting the image data of the document from the storage area if a predetermined event is detected after printing the document.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a structural diagram of an image forming apparatus consistent with the present invention.

FIG. 2 is a block diagram of a copy control system in an image forming apparatus consistent with the present invention.

FIG. 3 is a flow diagram of a copy control process consistent with the present invention.

FIGS. 4A-4C are graphical representations of exemplary display panels of an image forming apparatus during the copy control process of FIG. 3.

### DETAILED DESCRIPTION OF PREFERRED EMBODIMENT

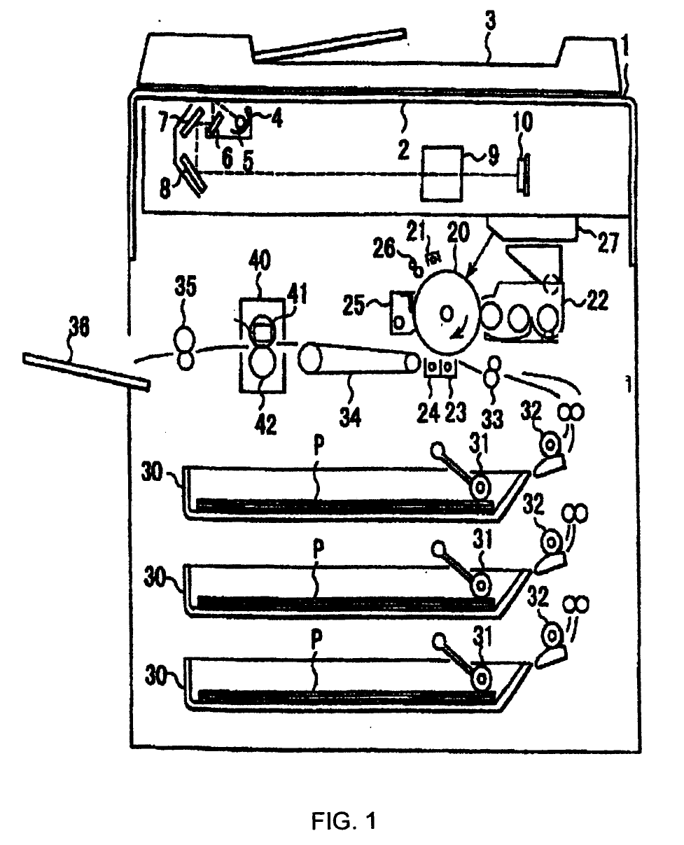

FIG. 1 shows a structural diagram of an image forming apparatus consistent with the present invention. As shown in FIG. 1, a document table 2 for placement of a page of a document is provided at an upper part of a main body 1. An automatic document feeder (ADF) 3 is provided on the document table 2. The ADF 3 automatically feeds pages of the document one sheet at a time onto the upper surface of the document table 2.

A carriage 4 is reciprocally and movably provided on the lower side of the document table 2. An exposure lamp 5 is provided on the carriage 4. The carriage 4 is reciprocally moved while the exposure lamp 5 is being turned on. Thus, the entire surface of the document table 2 is exposed and scanned.

The exposure scan obtains a reflection light image of the document page on the document table 2. The reflection light image is projected on a charge-coupled device (CCD) line sensor (CCD sensor) 10 via reflection mirrors 6, 7 and 8 and a magnification-variable lens block 9. The CCD sensor 10 outputs an image signal of a voltage level corresponding to a reception light amount. The image signal is supplied to a laser unit 27. The laser unit 27 emits a laser beam corresponding to the image signal.

A photosensitive drum 20 is rotatably provided within the main body 1. The photosensitive drum 20 is successively surrounded by an electrifying charger 21, a developing unit 22, a transfer charger 23, a separating charger 24, a cleaner 25, and a destaticizer 26. The laser beam emitted from the laser unit 27 is passed between the electrifying charger 21 and developing unit 22 and strikes the peripheral surface of the photosensitive drum 20.

A plurality of sheet feed cassettes 30 are disposed at a bottom portion of the main body 1 and is capable of holding large amounts of copying sheets P serving as recording media. Each sheet feed cassette 30 is provided with a pick-up roller 31 for picking up copying sheets P one sheet at a time.

At the time of copying, copying sheets P are picked up one sheet at a time from any sheet feed cassette 30. A separator 32 separates the picked-up copying sheet P from the sheet feed cassette 30, and the paper is fed to a register roller 33. The copying sheet P waits in this area for rotation of the photosensitive drum 20, and in accordance with the timing rotating the photosensitive drum 20, the register roller 33 feeds the copying sheet P between the transfer charger 23 and photosensitive drum 20.

When the copying operation is performed, the photosensitive drum 20 rotates clockwise, as shown in FIG. 1. The electrifying charger 21 applies a high voltage supplied from a high voltage supply section (not shown) to the photosensitive drum 20, and electrifies the surface of the photosensitive drum 20 with electrostatic charge. An electrostatic latent image is formed on the photosensitive drum 20 by the electrification and the radiation of the laser beam from the laser unit 27 on the photosensitive drum 20.

The developing unit 22 supplies a developer to the photosensitive drum 20. With the supply of the developer, the electrostatic latent image on the photosensitive drum 20 is changed to a visible image. The transfer charger 23 transfers the visible image (developer image) from the photosensitive drum 20 onto the copying sheet P fed from the register roller 33. The copying sheet P with the transferred image is separated from the photosensitive drum 20 by the separating charger 24. The separated copying sheet P is brought to a fixing unit 40 by a conveyor belt 34.

The fixing unit 40 comprises a heating roller 41 and a pressing roller 42. The copying sheet P is inserted between both rollers, and while the copying sheet P is being conveyed, the developer image on the copying sheet P is fixed by the heat of the heating roller 41. The copying sheet P coming out of the fixing unit 40 is output to a tray 36 by conveyance rollers 35.

The heating roller 41 may be, for example, an endless member having a metal layer, which is constructed by an iron cylinder having a thickness of, for example, 1 mm. A mould-releasing layer of Teflon or similar material may be formed on the surface of the member. In addition, stainless steel, aluminum, an alloy of stainless steel or aluminum, or some other similar material may be used for the heating roller 41.

The pressing roller 42 may be constructed by coating elastic material such as silicon rubber, fluoro rubber, or some other similar material on the circumference of a core metal. The pressing roller 42 is pressed against the heating roller 41 at a predetermined pressure by a press mechanism, which provides a nip (where the outer circumferential surface of the pressing roller 42 is elastically deformed by a press contact) having a predetermined width at a position where both rollers contact each other. As a copying sheet P passes through the nip, toner on the copying sheet P is melted and fixed to the copying sheet P.

During the operation of the image forming apparatus, a temperature sensor, such as a thermistor, detects the temperature of the heating roller 41 of the fixing unit 40. The detected temperature of the heating roller 41, which corresponds to a fixing temperature for fixing the developer image to the copying sheet P, may be received by a main processing unit or processor, such as a CPU, which can serve as a control unit for controlling the operation of the components of the image forming apparatus.

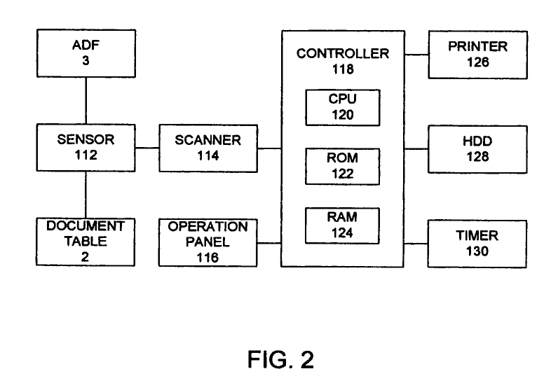

FIG. 2 is a block diagram of a copy control system in an image forming apparatus consistent with the present invention. As shown in FIG. 2, the copy control system includes the ADF 3 and the document table 2 of FIG. 1, as well as a sensor 112, a scanner 114, an operation panel 116, a controller 118, a printer 126, a hard disk drive (HDD) 128, and a timer 130. In addition, the controller 118 includes a CPU 120, a ROM 122, and a RAM 124.

The sensor 112 is coupled to the ADF 3 and the document table 2. The sensor 112 detects when a document has been placed into the ADF 3. In addition, the sensor 112 can detect when a page of a document has been placed on the document table 2 or when the panel on top of the document table 2 has been moved, such as to remove a page from the document table 2 or to place a new page on the document table 2. The pages fed by the ADF 3 or placed on the document table 2 are scanned by the scanner 114. The scanner 114 includes a lamp that exposes the page of the document and the reflected light is detected by a charge-coupled device (CCD), which outputs an image signal corresponding to the scanned page. The image signal may be black and white (BAN) data if the image forming apparatus is monochromatic or red, green, and blue (RGB) data if the image forming apparatus is color.

To initiate the copy job, the user enters settings and parameters through the operation panel 116. The operation panel 116 preferably includes a display and either buttons that are depressed by the user or a touch pad on the display. The settings and parameters of the copy job are entered by the depressing the buttons or touching the touch pad.

The controller 118 controls the operation of the copy control system. The CPU 120 is a processor that enables the controller 118 to execute instructions for performing a copy control process, described in further detail herein. The instructions are preferably stored in a non-volatile memory, such as the ROM 122. The controller also has a volatile memory, the RAM 124, which operates as a working memory during the execution of the copy control process. The controller 118 receives the settings and parameters for the copy job from the operation panel 116 and initiates the copy control process in response to the copy job, including controlling the feeding of pages of the document by the ADF 3 and the scanning of each page by the scanner 114. In addition, the controller 118 can perform various image processing functions on the image data generated by the scanner 114.

The printer 126 generates a copy or printout of the image data generated by the scanner 114 and processed by the controller 118. The printer 126 can be, for example, a laser type printer, such as described in FIG. 1, or an inkjet or bubble jet type printer. In addition, the printer 126 can be a color or a monochrome printer.

The HDD 128 is a non-volatile storage medium capable of storing image data generated by the scanner 114. After a page is scanned, the controller 118 can store the image data generated by the scanner 114 in the HDD 128, as well as encrypt the image data stored in the HDD 128. As will be described in more detail below, the HDD 128 is preferably configured to store the image data of all of the pages of a scanned document to enable additional copies of the document to be printed without rescanning the document. Furthermore, to protect against unauthorized reproduction of the image data, the HDD 128 only holds the image data of the document currently being copied, and the image data is deleted in response to a predetermined event after the document is copied. Although shown as a hard disk drive, the HDD 128 can alternatively be implemented as another type of non-volatile storage such as an NVRAM or flash memory. Regardless of the implementation, the area for storing the image data is preferably of a size sufficient to hold the image data of any document being copied. The timer 130 is controlled by the controller 118 to count time or be cleared in response to certain events occurring at the image forming apparatus.

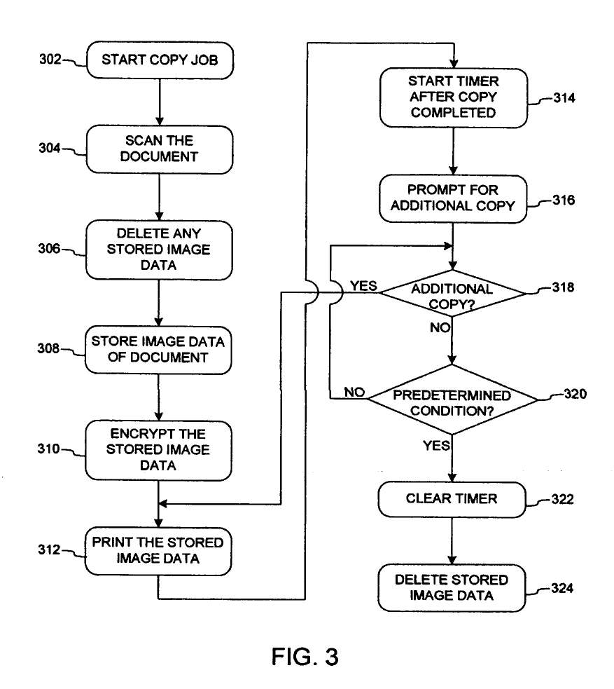

FIG. 3 is a flow diagram of a copy control process consistent with the present invention. As shown in FIG. 3, a user starts a copy job (step 302). As described above, the user can place the document being copied in the ADF 3 or put a page on the document table 2. In addition, the user enters the settings and parameters for the copy job through the operation panel 116. The settings and parameters include, for example, color or BAN copy, magnification, number of copies, stapling, hole-punching, N-up, double siding, etc. After entering all of the desired settings and parameters, the user selects a start button on the operation panel 116.

In response to the start of the copy job, the controller 118 controls the scanner 114 to scan each page of the document (step 304). If the document is present in the ADF 3, then the controller 118 directs the ADF 3 to feed each page of the document onto the document table 2, where it is scanned by the scanner 114. The scanner 114 generates image data for each page of the document being copied. As described above, the image data may be BNV data or color (RGB) data.

In addition to controlling the copying of the document, the controller 118 deletes any image data of a previously copied document from the HDD 128 (step 306). If there is image data of a previously copied document in the HDD 128, then the controller 118 deletes it from the HDD 128 in response to, for example, the start of the copy job, the placement of the document being copied in the ADF 3, the opening of the panel over the document table 2, a clear instruction, or the passage of a predetermined amount of time since the completion of the copying of the previously copied document. The deletion of the image data ensures that no unauthorized reproductions of the previously copied document can be made and that the image data of no more than one document is maintained in the HDD 128.

The controller 118 stores in the HDD 128 the image data generated by the scanner 114 of the document being copied (step 308). The controller 118 can also encrypt the image data stored in the HDD 128 (step 310). The image data can be encrypted using any of a number of well known encryption algorithms as would be understood by one skilled in the art. The encryption of the image data is not required. However, by encrypting the image data stored in the HDD 128, it is possible to protect the image data from being reproduced without authorization. To decrypt the image data so that it can be reproduced, a user may be required to enter a user ID and a password or other form of verification.

The controller 118 also provides the image data of the document being copied to the printer 126 for printing (step 312). The controller 118 may provide the image data from the HDD 128 after all of the image data has been stored in the HDD 128. Alternatively, the controller 118 can provide the image data of each page from the scanner 114 to the printer 126 without first storing the image data in the HDD 128, such as by using a temporary storage area like a page memory. The controller 118 converts the image data into a format, such as a raster image, that is understood by the printer 126.

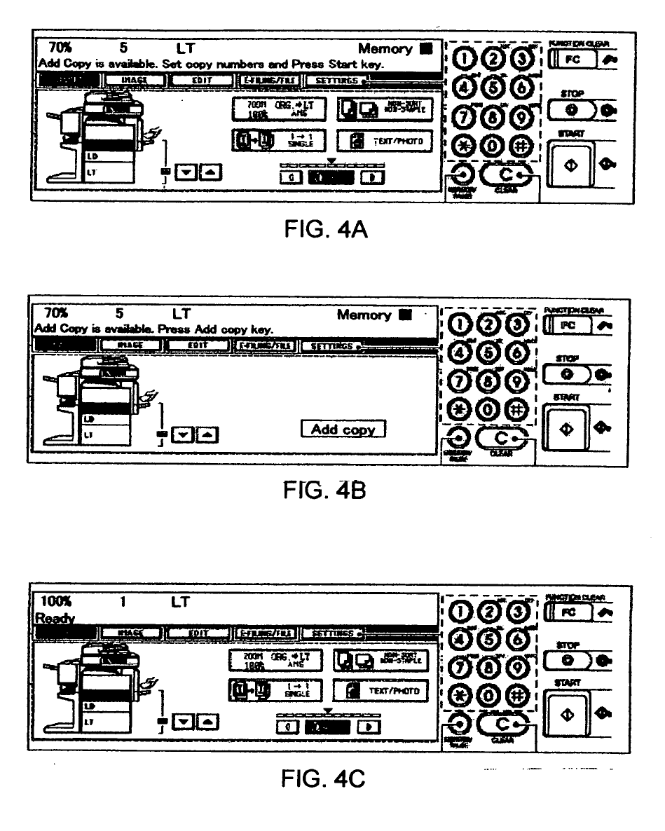

When the printer 126 has finished printing, and the copy job is complete, the controller 118 starts the timer 130 (step 314). The timer 30 can be controlled to count up to a predetermined time or threshold or to start at the predetermined time and count down to zero. In addition to starting the timer 30, the controller 118 prompts the user to determine if additional copies should be made (step 316). The prompt is preferably made through a display in the operation panel 116. FIGS. 4A and 4B are graphical representations of exemplary displays of the operation panel 116 prompting the user to request additional copies to be made. Although the copy control process of FIG. 3 shows that the controller 118 generates the prompt for additional copies after the copy is complete, it is possible for the prompt to be generated any time after the copy job is first started, such as after the scanner 114 starts to scan the first page of the document.

While the prompt for additional copies is displayed to the user, the controller 118 checks to see if the user has requested additional copies (step 318). As shown in FIGS. 4A and 4B, to request additional copies, the user can, for example, set the desired number of copies and select ‘start’ or the user can select a dedicated ‘add copy’ button. It should be understood that other configurations of the operation panel 116 are possible for making the request for additional copies, and that the graphical representations shown in FIGS. 4A and 4B are merely exemplary.

If the controller 118 determines a request for additional copies has been made, then processing returns to step 312 and the requested number of copies is made using the image data stored in the HDD 128. Accordingly, if a user desires to make one or more copies of the document after starting the copy job, the user does not have to refeed and rescan the document. Rather, the image data of the document being copied is maintained in the HDD 128, and the controller 118 can provide that data to the printer 126 for printing. If the image data stored in the HDD 128 is encrypted, the user may be required to provide a user ID and password or other verification to ensure that the user is authorized to make a reproduction of the image data. If the user provides the proper verification, then the controller 118 decrypts the image data and provides the decrypted image data to the printer 126 for printing.

If the user does not request any additional copies, then the controller 118 determines if any predetermined conditions or events have occurred (step 320). The predetermined condition or event can be, for example, the placement of a document in the ADF 3, the opening of the panel over the document table 2 or the placement of a document on the document table, a clear instruction, or the passage of a predetermined amount of time since the completion of the copying of the document. For example, if the user places a document in the ADF 3 or opens the panel over the document table 2, then the sensor 112 detects that event and provides a signal to the controller 118. The controller 118 recognizes the signal from the sensor 112 as a predetermined event. The detection by the sensor 112 can occur after the copy job is complete or any time after the copy job has started. The clear instruction may be initiated by the user selecting a clear button on the operation panel 116. The clear instruction, which may be initiated anytime after the copy job has started or only after completing the copy job, is received by the controller 118, which identifies the instruction as a predetermined event. The controller 118 also monitors the timer 130 to determine if it has reached the predetermined time, such as one minute, or has counted to zero from the predetermined time. The predetermined time may be a fixed time or may be set by a user or administrator of the image forming apparatus. If the timer 130 has reached the predetermined time or reached zero from the predetermined time, then the controller 118 also identifies that as a predetermined event.

If no predetermined condition or event is detected by the controller 118, then the controller 118 continues to check for a request for additional copies and the occurrence of a predetermined condition or event (steps 318 and 320). If the controller 118 detects a predetermined condition or event, then the controller 118 clears the timer 130 (step 322). The controller 118 clears the timer 130 by resetting it to zero or to the predetermined time, depending on whether the timer 130 is configured to counter up or down.

In addition to clearing the timer 130, the controller 118 deletes the image data stored in the HDD 128 (step 324). When the image data is deleted from the HDD 128, it is no longer possible to reproduce the document being copied without rescanning the document. Accordingly, when the image data is deleted, the controller 118 can change the display of the operation panel to a default or reset setting, such as shown in FIG. 4C.

Like the deletion of the image data of a previously copied document in step 306, the deletion of the image data in response to detecting the predetermined condition or event ensures that no unauthorized reproductions of the document can be made and that the image data of no more than one document is maintained in the HDD 128. Also, by maintaining the image data of only one document in the HDD 128, it is not necessary to have a very large memory for storing image data. As a result, it is possible to generate additional copies of a document being copied without rescanning the document, while also minimizing the cost of the memory needed for the image forming apparatus to hold the image data of the document.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for copying a document in an image forming apparatus, comprising:
receiving a request to copy a document;
scanning the document to form image data corresponding to the document;
printing the document using the image data of the document;
storing the image data of the document in a storage area of the image forming apparatus;
reprinting the document using the image data stored in the storage area of the image forming apparatus if a request is received for at least one additional copy of the document; and
deleting the image data of the document from the storage area if a predetermined event is detected after printing the document.

2. A method according to claim 1, further comprising:
deleting any other image data in the storage area of the image forming apparatus before initiating the copy request.

3. A method according to claim 2, wherein the other image data deleted from the storage area of the image forming apparatus corresponds to image data of a previously copied document.

4. A method according to claim 1, wherein the predetermined event is passage of a predetermined time after completing the printing of the document.

5. A method according to claim 4, wherein the predetermine time is about one minute.

6. A method according to claim 1, wherein the predetermined event is detection of a document placed in an automatic document feeder of the image forming apparatus.

7. A method according to claim 1, wherein the predetermined event is opening of a document table of the image forming apparatus.

8. A method according to claim 1, wherein the predetermined event is detection of a document on a document table of the image forming apparatus.

9. A method according to claim 1, wherein the predetermined event is receiving a clear operation instruction.

10. A method according to claim 1, further comprising:
encrypting the image data stored in the storage area of the image forming apparatus;
receiving a request for an additional copy of the document; and
decrypting the image data stored in the storage area of the image forming apparatus if the request includes a proper verification,
wherein the document is reprinted using the decrypted image data.

11. A method according to claim 10, wherein the proper verification includes a username and password.

12. A method according to claim 1, wherein the document is reprinted without rescanning the document.

13. A method according to claim 1, where the request for at least one additional copy is received in response to a user input made at the image forming apparatus.

14. A method according to claim 13, wherein the request for at least one additional copy is received before the copy job is complete.

15. A method according to claim 1, wherein image data of only one document is maintained in the storage area of the image forming apparatus.

16. An image forming apparatus, comprising:
a scanner that scans a document to form image data corresponding to the document in response to a request to copy the document;
a printer that prints the document using the image data of the document;
a storage area that stores the image data of the document;
a processor; and
a memory, coupled to the processor, comprising a plurality of instructions executed by the process, the plurality of instructions configured to:
reprint the document using the image data stored in the storage area of the image forming apparatus if a request is received for at least one additional copy of the document; and
delete the image data of the document from the storage area if a predetermined event is detected after printing the document.

17. An image forming apparatus according to claim 16, the memory further comprising an instruction configured to delete any other image data in the storage area of the image forming apparatus before initiating the copy request.

18. An image forming apparatus according to claim 17, wherein the other image data deleted from the storage area of the image forming apparatus corresponds to image data of a previously copied document.

19. An image forming apparatus according to claim 16, wherein the predetermined event is passage of a predetermined time after completing the printing of the document.

20. An image forming apparatus according to claim 19, wherein the predetermine time is about one minute.

21. An image forming apparatus according to claim 16, wherein the predetermined event is detection of a document placed in an automatic document feeder of the image forming apparatus.

22. An image forming apparatus according to claim 16, wherein the predetermined event is opening of a document table of the image forming apparatus.

23. An image forming apparatus according to claim 16, wherein the predetermined event is detection of a document on a document table of the image forming apparatus.

24. An image forming apparatus according to claim 16, wherein the predetermined event is receiving a clear operation instruction.

25. An image forming apparatus according to claim 16, the further comprising instructions configured to:
encrypt the image data stored in the storage area of the image forming apparatus;
receive a request for an additional copy of the document; and
decrypt the image data stored in the storage area of the image forming apparatus if the request includes a proper verification,
wherein the document is reprinted using the decrypted image data.

26. An image forming apparatus according to claim 25, wherein the proper verification includes a username and password.

27. An image forming apparatus according to claim 16, wherein the document is reprinted without rescanning the document.

28. An image forming apparatus according to claim 16, where the request for at least one additional copy is received in response to a user input made at the image forming apparatus.

29. An image forming apparatus according to claim 28, wherein the request for at least one additional copy is received before the copy job is complete.

30. An image forming apparatus according to claim 16, wherein image data of only one document is maintained in the storage area of the image forming apparatus.
